(19) United States
(12) Patent Application Publication
(10) Pub. No.: US 2022/0280951 A1
(43) Pub. Date: Sep. 8, 2022

(54) FLOTATION SLURRY CONDITIONING METHOD BASED ON CONTROLLING INTERFACIAL MICRO-NANO BUBBLES

(71) Applicant: WUHAN UNIVERSITY OF TECHNOLOGY, Wuhan (CN)

(72) Inventors: Siyuan YANG, Wuhan (CN); Lizhangzheng WANG, Wuhan (CN)

(21) Appl. No.: 17/683,385

(22) Filed: Mar. 1, 2022

(30) Foreign Application Priority Data
Mar. 1, 2021 (CN) 202110232401X

(51) Int. Cl. B03D 1/02

(52) U.S. Cl. CPC B03D 1/028

(57) ABSTRACT

A flotation slurry conditioning method based on controlling interfacial micro-nano bubbles includes steps of adding slurry and flotation reagents into a stirring equipment to make minerals evenly dispersed and fully interact with the flotation reagents; and conveying slurry mixture obtained into a flotation cell for flotation; during a conveying process of the slurry mixture, adjusting a fluid pressure in different conveying sections to make surfaces of minerals in the slurry mixture generating interfacial micro-nano bubbles. A flow velocity of the slurry mixture is increased by changing inner diameters of the different conveying sections to reduce the fluid pressure. Sizes and contact angles of the interfacial micro-nano bubbles generated on surfaces of the minerals are controlled by the change of flow velocity of the slurry mixture, so floatability of the minerals is selectively improved, and hydrophobic agglomeration of fine-grained minerals is promoted.

### TECHNICAL FIELD

The present disclosure relates to a field of mineral processing, and in particular to a flotation slurry conditioning method based on controlling interfacial micro-nano bubbles.

### BACKGROUND

Development and utilization of mineral resources play a pivotal role in national economic development. With long-term exploitation of mineral resources, high-quality parts have been gradually depleted. Thus, the effective recovery and utilization of poor and fine mineral resources are imminent. The flotation method is the most important beneficiation method of fine-grained minerals, it usually needs to add various chemical agents during the slurry conditioning stage before turning on the air supply to strengthen the surface properties differences of different minerals, thereby improving flotation separation efficiency.

Conventional flotation reagents generally contain a certain degree of toxicity. If return water of the flotation reagents is used, it easily affects a flotation effect, if the flotation reagents are direct discharge, it causes environmental pollution. With the advancement of national policies such as green mines and energy conservation and emission reduction, in order to prevent harms caused by flotation reagents to the ecological environment, it is necessary to explore efficient and environmentally friendly flotation slurry conditioning methods.

A conventional flotation stirring-type conditioning method only provides a fluidization environment to make the flotation reagents interact with the minerals. The treatment of fine minerals using the conventional flotation stirring-type conditioning method normally requires a large amount of reagents with low separation efficiency and easily causes environmental pollution. Due to the difference in the hydrophobicity and roughness of the mineral surfaces, the difficulties of dissolved gas molecules to aggregate and generate the heterogeneous gas core on various minerals are different. The interfacial micro-nano bubbles formed based on the aggregation of supersaturated dissolved gas molecules have the characteristics of high selectivity, controllability, bridging effect, and low energy consumption.

On one hand, although there are many studies on methods of slurry mixing, the interfacial micro-nano bubbles with various good characteristics are not paid enough attention; On the other hand, it is particularly important to know relevant change rules during the generation and growth of the interfacial micro-nano bubbles, which is particularly important for effectively adjusting the selective generation of a large number of interfacial micro-nano bubbles on the mineral surfaces.

Thus, it is of great significance to provide a flotation slurry conditioning method based on controlling the generation of the interfacial micro-nano bubbles to selectively change hydrophobic properties of the mineral surfaces and establish a growth model of the interfacial micro-nano bubbles to realize accurate prediction of time-dependent changes of a bubble radius and contact angle during the growth of the interfacial micro-nano bubbles. It is also of great significance to obtain a numerical model of a pipe diameter, a length, and a slurry flow velocity of each conveying section of the interfacial micro-nano bubble controller by combining the Bernoulli equation, and optimal parameters are selected according to the actual situation, so as to optimize hydrophobicity difference of the mineral surfaces and realize purposes of improving a flotation separation efficiency and reducing the chemical dosage.

### SUMMARY

In view of above problems, a purpose of the present disclosure is to provide a flotation slurry conditioning method based on controlling interfacial micro-nano bubbles. The flotation slurry conditioning method of the present disclosure is based on an interfacial micro-nano bubbles control device. Interfacial micro-nano bubbles are generated on mineral surfaces by the interfacial micro-nano bubble control device, so as to selective change the mineral surface hydrophobicity, increase wettability difference between minerals, and solve problems of low efficiency, high cost, and large dosage of flotation reagents in conventional flotation stirring-type conditioning method

To achieve the above object, the present disclosure provides a flotation slurry conditioning method based on controlling interfacial micro-nano bubbles.

The flotation slurry conditioning method based on controlling the interfacial micro-nano bubbles comprises the following steps:

step 1: adding slurry and flotation reagents into a stirring equipment to make minerals evenly dispersed and fully interact with the flotation reagents; and

step 2: conveying slurry mixture obtained in the step 1 into a flotation cell for flotation; during a conveying process of the slurry mixture, adjusting a fluid pressure in different conveying sections to make surfaces of the minerals in the slurry mixture generating interfacial micro-nano bubbles.

Optionally, the different conveying sections at least comprise a first conveying section and a second conveying section arranged in sequence along a conveying direction. An inner diameter of the first conveying section is greater than an inner diameter of the second conveying section.

Optionally, a length of the second conveying section is obtained by:

step 21: building a model to obtain a generation time T of the interfacial micro-nano bubbles and a pressure difference ΔP between the first conveying section and the second conveying section when a surface area difference of the interfacial micro-nano bubbles generated on surfaces of different minerals reaches maximum;

step 22: obtaining a flow velocity of the slurry mixture in the second conveying section by combining the pressure difference ΔP obtained in step 21 and the Bernoulli's equation;

$${v}_{2} = \sqrt{2 g Δ H + {v}_{1}^{2} + \frac{2 ( {P}_{1} - {P}_{2} )}{ρ}} \qquad ( 1 )$$

P₁ represents a pressure of the slurry mixture in the first conveying section. P2 represents a pressure of the slurry mixture in the second conveying section. ΔP=P₁-P₂. v₁ represents a flow velocity of the slurry mixture in the first conveying section. v₂ represents the flow velocity of the slurry mixture in the second conveying section. ρ represents a density of the slurry mixture; g represents an acceleration of gravity. ΔH represents a height difference between the first conveying section and the second conveying section. It should be noted that the interfacial micro-nano bubbles are generated when ambient pressure drop and the generation time T of the interfacial micro-nano bubbles is equal to the time T for the slurry mixture to pass through the second conveying section.

step 23: obtaining the length of the second conveying section according to the generation time T of the interfacial micro-nano bubbles obtained in step 21 and the flow velocity of the slurry mixture in the second conveying section;

L=v₂T (2)

L represents the length of the second conveying section. T represents time for the slurry mixture to pass through the second conveying section.

Optionally, the interfacial micro-nano bubbles are spherical cap bubbles. The step of building the model in step 21 comprises:

step 211: establishing a preliminary formula of a surface area of a single spherical cap bubble; establishing a preliminary formula of a volume change rate during bubble growth of a single spherical cap bubble; establishing a preliminary formula of a volume of the single spherical cap bubble;

the surface area of the single spherical cap bubble is:

S=2πRh=2πR²(1+cosθ) (3)

the volume change rate during bubble growth of the single spherical cap bubble is:

$$\frac{d V}{d t} = \frac{π D R sin θ}{{ρ}_{g}} [ {C}_{∞} - {C}_{s} ( 1 + \frac{2 σ}{R P} ) ] f ( θ ) ; \\ where \qquad ( 4 )$$

$$f ( θ ) = \frac{sin θ}{1 - cos θ} + 4 {\int }_{0}^{∞} \frac{1 + cosh [ 2 ( π - θ ) τ ]}{sinh 2 π τ} tanh ( θτ ) {d}_{τ} ; \qquad ( 5 )$$

the volume of the single spherical cap bubble is:

$$V = \frac{π {R}^{3} ( 2 + 3 cos θ - {cos}^{3} θ )}{3} \qquad ( 6 )$$

h represents a height of the spherical cap bubble. θ represents a contact angle of the single spherical cap bubble. R represents a radius of the single spherical cap bubble. V represents a volume of the single spherical cap bubble. t represents a growth time of the single spherical cap bubble. D represents a diffusion coefficient of dissolved gas. ρ_{g} represents density of gas in the interfacial micro-nano bubbles generated on the surfaces of different types of minerals. P represents ambient pressure. σ represents bubble-liquid interfacial tension. C_{∞} represents a concentration of dissolved gas at an infinite distance from the single spherical cap bubble. Cₛ represents an concentration of the dissolved gas. t represents dimensionless time.

step 212: establishing models of the single spherical cap bubble in different stages during a changing process of θ and R; wherein the different stages of the single spherical cap bubble comprise a floating stage where the contact angle of the single spherical cap bubble is changing and the radius of the single spherical cap bubble is constant, a transition stage where the radius and the contact angle of the single spherical cap bubble are changing, and an expansion stage where the radius of the single spherical cap bubble is changing and the contact angle of the single spherical cap bubble is constant;

Based on the diffusion theory, a model of the single spherical cap bubble in the floating stage where the contact angle of the single spherical cap bubble is changing and the radius of the single spherical cap bubble is constant is obtained from formulas (4) (5) (6) as follows:

$$\frac{d θ}{dt} = \frac{d V}{dt} \times \frac{1}{dV / d θ} = \frac{D}{ρ {R}^{2} {sin}^{2} θ} [ {C}_{s} ( 1 + \frac{2 σ}{R P} ) - {C}_{∞} ] f ( θ ) . \qquad ( 7 )$$

Based on the diffusion theory, a model of the single spherical cap bubble in the transition stage where the radius and the contact angle of the single spherical cap bubble are changing is obtained from the formulas (4) (5) (6) as follows:

$$\frac{d θ}{dt} = \frac{( 4.5 + 6.75 cos θ - 2.25 {cos}^{3} θ \times {10}^{- 6}}{R {sin}^{3} θ} + \frac{D}{ρ {R}^{2} {sin}^{2} θ} [ {C}_{s} ( 1 + \frac{2 σ}{R P} ) - {C}_{∞} ] f ( θ ) . \qquad ( 8 )$$

Based on the diffusion theory, a model of the single spherical cap bubble in the expansion stage where the radius of the single spherical cap bubble is changing and the contact angle of the single spherical cap bubble is constant is obtained from the formulas (4) (5) (6) as follows:

$$\frac{d R}{dt} = \frac{d V}{dt} \times \frac{1}{dV / dR} = D \frac{{C}_{∞} - {C}_{s} ( 1 + \frac{2 σ}{R P} )}{ρ R {sin}^{3} θ} \frac{{( 1 - cos θ )}^{2}}{( 2 - cos θ )} f ( θ ) . \qquad ( 9 )$$

step 213: determining a change curve of the surface area S of the single spherical cap bubble at different time points t under different pressure differences ΔP by the Henry's formula and formulas (3), (7), (8), and (9); obtaining the generation time T of the interfacial micro-nano bubbles and the pressure difference AP according to the change curve when the surface areas difference of the interfacial micro-nano bubbles generated on the surfaces of different minerals reaches the maximum.

The Henry's formula is:

Cₛ=K_{H}P₂, C_{∞}=K_{H}P₁, ΔP=P₁-P₂;

K_{H} represents Henry's constant. A value of the Henry's constant is affected by temperature and solution properties. C_{∞} represents the concentration of the dissolved gas at the infinite distance from the single spherical cap bubble. Cₛ represents the concentration of the dissolved gas. It should be noted that the above formulas reveal a co-evolution law of the interfacial micro-nano bubbles. However, in practical applications, the interfacial micro-nano bubbles are generated at different times and are generated in a different order under the same conditions. Thus, it is necessary to further refer to preliminary experimental results of three-dimensional observation of interfacial micro-nano bubble groups generated on the surfaces of different minerals in the slurry mixture to deduce an evolution law of a single interfacial micro-nano bubble to practice interfacial micro-nano bubbles, thereby obtaining effective values of T and ΔP in specific cases.

Optionally, the step 22 further comprises determining the inner diameter D2 of the second conveying section:

$${D}_{2} = {D}_{1} \sqrt{\frac{{v}_{1}}{{v}_{2}}} . \qquad ( 10 )$$

D₁ is the inner diameter of the first conveying section. D₂ is the inner diameter of the second conveying section.

Optionally, the slurry is selected from non-ferrous metal sulfide slurry, non-ferrous metal oxide slurry; non-metallic slurry, ferrous metal slurry, oxygen-containing salt slurry, and coal slurry.

Optionally, the flotation reagents are one or more of a collector, a pH adjuster, an depressant, and a foaming agent.

Compared with the prior art, the slurry is conditioned by an interfacial micro-nano bubble controller. Since an inner diameter of the second conveying section of the interfacial micro-nano bubble controller is less than an inner diameter of the first conveying section, the flow velocity of the slurry mixture increases when passing through the second conveying section, so as to form a pressure reduction. The reduced pressure is still above a saturated steam pressure, so that the slurry mixture in the second conveying section generates a large number of interfacial micro-nano bubbles on surfaces of minerals with higher hydrophobicity due to sudden pressure drop. Differing from cavitation/vapor bubbles, the interfacial micro-nano bubbles are air bubbles generated by the diffusion phenomenon caused by the difference in dissolved gas concentration, which have characteristics of high selectivity, controllability, bridging effects, and low energy consumption. The large number of interfacial micro-nano bubbles generated on the surfaces of the minerals further improve the hydrophobicity of hydrophobicy/rough minerals, so as to achieve the effect of selectively change the hydrophobicity of the surfaces of the minerals, expanding wettability difference between minerals, improving efficiency of mineral flotation, and reducing environmental pollution caused by the flotation reagents.

### BRIEF DESCRIPTION OF DRAWINGS

FIG. 1 is a schematic structural diagram of a flotation slurry conditioning device for a flotation slurry conditioning method based on controlling interfacial micro-nano bubbles of the present disclosure according to one embodiment of the present disclosure.

FIG. 2 is a flow chart of the flotation slurry conditioning method based on controlling the interfacial micro-nano bubbles of the present disclosure according to one embodiment of the present disclosure.

FIG. 3 is a schematic structural diagram of an interfacial micro-nano bubble controller of the present disclosure.

FIG. 4 is a flow chart of a principle of slurry conditioning and flotation of the present disclosure.

FIG. 5 is a schematic structural diagram of a conventional stirring-type conditioning device in the prior art.

### DETAILED DESCRIPTION

Principles and features of the present disclosure will be described below with reference to the accompanying drawings. The embodiments are only used to explain the present disclosure rather than limit the scope of the present disclosure. The present disclosure is described in more detail by providing examples in the following paragraphs with reference to the accompanying drawings. Advantages and features of the present disclosure will become apparent from the following description and claims. It should be noted that the accompanying drawings are provided in a very simplified form and use inaccurate scales, and are only used to facilitate and clearly assist the purpose of explaining the embodiments of the present disclosure.

The present embodiment provides a flotation slurry conditioning method based on controlling interfacial micro-nano bubbles that comprises following steps:

Step 1: adding slurry and flotation reagents into a stirring equipment to make minerals evenly dispersed and fully interact with the flotation reagents; and

Step 2: conveying slurry mixture obtained in the step 1 into a flotation cell for flotation; during a conveying process of the slurry mixture, adjusting a fluid pressure in different conveying sections to make surfaces of the minerals in the slurry mixture generating interfacial micro-nano bubbles.

In the embodiment, the adjusting of the fluid pressure in different conveying sections is realized by changing inner diameters of the conveying sections. In the embodiment, the different conveying sections at least comprise a first conveying section and a second conveying section arranged in sequence along a conveying direction. The inner diameter of the first conveying section is greater than the inner diameter of the second conveying section. Since the inner diameter of the first conveying section is greater than the inner diameter of the second conveying section, a flow velocity of the slurry mixture increases when passing through the second conveying section, so as to reduce pressure. The reduced pressure is still above the saturated steam pressure, so that the slurry mixture in the second conveying section generates a large number of interfacial micro-nano bubbles on surfaces of minerals with higher hydrophobicity due to sudden pressure drop.

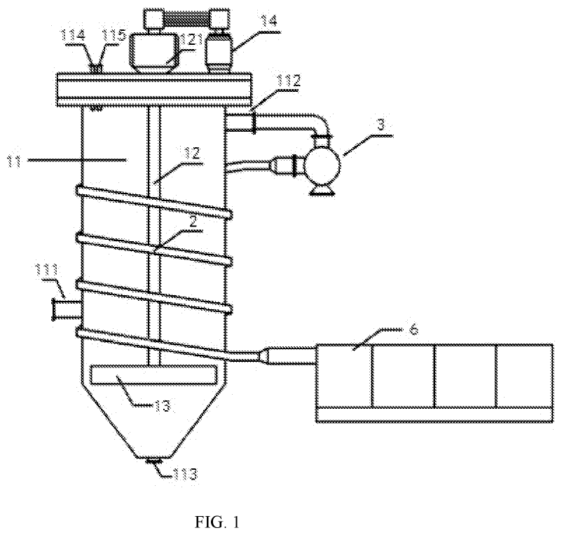

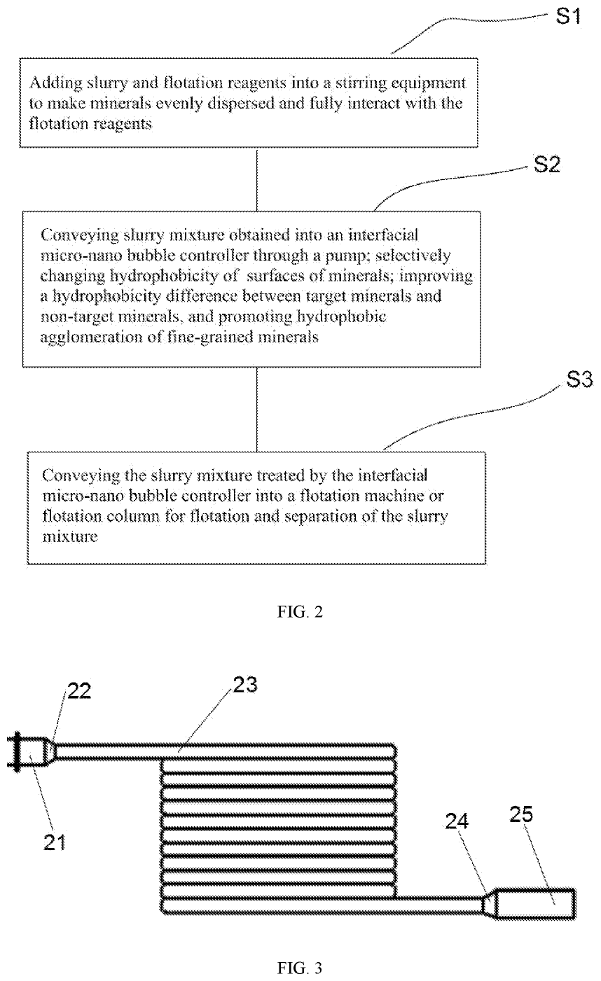

A flotation slurry conditioning device for the flotation slurry conditioning method of the present disclosure is shown in FIG. 1. The embodiment provides the flotation slurry conditioning device that includes a stirring equipment 1, a driving equipment 3, and an interfacial micro-nano bubble controller 2. The stirring equipment 1 is configured to stir the slurry mixture, so that materials in the slurry are evenly mixed. The driving equipment 3 is configured to covey the slurry mixture stirred by the stirring equipment 1 to the interfacial micro-nano bubble controller 2. The interfacial micro-nano bubble controller 2 comprises conveying sections having different inner diameters. After the slurry mixture enters the interfacial micro-nano bubble controller 2, surfaces of the minerals in the slurry mixture generate interfacial micro-nano bubbles due to the sudden pressure drop. The generated interfacial micro-nano bubbles modify surface properties of the minerals or make hydrophobic agglomeration of fine-grained minerals, thereby improving efficiency of mineral flotation and reducing a dosage of the flotation reagents.

The stirring equipment 1 in the embodiment maybe a conventional stirring equipment, or in the embodiment, the stirring equipment 1 optionally adopts following method. The stirring equipment 1 comprises a slurry stirring barrel 11, a transmission shaft 12, an impeller 13, and a power source 14. An upper portion of the slurry stirring barrel 11 is cylindrical and a lower portion of the slurry stirring barrel 11 is a funnel-shaped structure. The lower portion of the slurry stirring barrel 11 defines a slurry inlet 111 and the upper portion of the slurry stirring barrel 11 defines a slurry outlet 112. A lower end of the funnel-shaped structure defines an auxiliary discharging port 113. The auxiliary discharging port 113 is configured to discharge all the slurry mixture in the slurry stirring barrel 11 when the stirring equipment 1 is overhauled or out of order. An upper end of the slurry stirring barrel 11 defines a dosing port 114 and a water supply port 115. The flotation reagents are added through the dosing port 114 during a mixing process and water is added through the water supply port 115 during the mixing process. A first end of the transmission shaft 12 is disposed in the slurry stirring barrel 11 and is connected to the impeller 13, and a second end of the transmission shaft 12 passes through the slurry stirring barrel 11 and is connected to the power source 14. The power source 14 is optionally a motor, and the motor drives the transmission shaft through a belt. A bearing body 121 is disposed on a top end of the transmission shaft 12. The bearing body 121 ensures stable rotation of the transmission shaft 12.

The interfacial micro-nano bubble controller 2 of the embodiment comprises a first pipe body 21 and a second pipe body 23. A first end of the first pipe body is connected to the slurry outlet 112 of the stirring equipment, and a second end of the first pipe body 21 is connected to the second pipe body 23. The driving equipment 3 conveys the slurry mixture to enter the first pipe body 21 and the second pipe body 23 in sequence from the stirring equipment 1. In the embodiment, an inner diameter of the first pipe body 21 is greater than an inner diameter of the second pipe body 23. By changing the inner diameter of the second pipe body 23, when the slurry mixture flows from the first pipe body 21 into the second pipe body 23, a flow velocity of the slurry mixture increases. Correspondingly, after the slurry mixture flows into the second pipe body 23, the pressure in the slurry mixture is suddenly reduced, and dissolved gas in the slurry mixture diffuses under action of pressure reduction and forms interfacial micro-nano bubbles on the surfaces of the minerals.

Since the flow velocity of the second pipe body 23 is relatively high, in order to reduce the flow velocity and facilitate storage of the slurry mixture, the interfacial micro-nano bubble controller 2 in the embodiment further comprises a third pipe body 25. The third pipe body 25 is coaxially connected to a discharge end of the second pipe body 23. An inner diameter of the third pipe body 5 is greater than the inner diameter of the second pipe body, so when the slurry mixture flows from the second pipe body 23 into the third pipe body 25, the flow velocity of the slurry mixture is reduced, which reduces impact force of the slurry mixture, and facilitate collection and storage of the slurry mixture by a subsequent storage device. In the specific configuration, the inner diameter of the first pipe body 21 is generally optionally configured to be approximately the same as the inner diameter of the third pipe body 25 to ensure approximate symmetry of the interfacial micro-nano bubble controller 2. It should be noted that, in the embodiment, the inner diameter of the third pipe body 25 may configured to be different with the inner diameter of the first pipe body 21, For example, the inner diameter of the third pipe body 25 may configured to be greater than the inner diameter of the first pipe body 21, which is not limited thereto.

In order to facilitate smooth flow of the slurry mixture between the first pipe body 21, the second pipe body 23, and the third pipe body 25, and in order to reduce the resistance generated by differences in the inner diameters of the first pipe body 21, the second pipe body 23, and the third pipe body 25, the interfacial micro-nano bubble controller 2 in the embodiment further comprises a first connecting pipe body 22 and a second connecting pipe body 24. The first connecting pipe body 22 is disposed between the first pipe body 21 and the second pipe body 23, and the first connecting pipe body 22 is configured to communicate the first pipe body 21 with the second pipe body 23. The second connecting pipe body 24 is disposed between the second pipe body 23 and the third pipe body 25 and is configured to communicate the second pipe body 23 with the third pipe body 25. An inner diameter of the first connecting pipe body 22 gradually decreases from a first end close to the first pipe body 21 to a second end away from the first pipe body 21. An inner diameter of the second connecting pipe body 24 gradually increases from a first end close to the second pipe body 23 to a second end away from the second pipe body 23. In the embodiment, the inner diameter of the first connecting pipe body 22 and the inner diameter of the second connecting pipe body 24 are gradually changed to realize the smooth flow of the slurry mixture between the first pipe body 21 and the second pipe body 23 and realize the smooth flow of the slurry mixture between the second pipe body 23 and the third pipe body 25, so as to solve a problem of excessive flow resistance caused by the sudden change of the inner diameters. Optionally, in the embodiment, an inner diameter of the first end of the first connecting pipe body 22 is the same as the inner diameter of the first pipe body 21, An inner diameter of the second end of the first connecting pipe body 22 is the same as the inner diameter of the second pipe body 23. An inner diameter of the first end of the second connecting pipe body 24 is the same as the inner diameter of the second pipe body 23. An inner diameter of the second end of the second connecting pipe body 24 is the same as the inner diameter of the third pipe body 23. Thus, a smooth transition of the inner diameters between the first pipe body 21, the second pipe body 23 and the third pipe body 25 is realized, the resistance of the flow of the slurry mixture is reduced to the greatest extent, and the stability of the flow of the slurry mixture is improved.

The second pipe body 23 may be configured in a form of a straight pipe, and optionally, be configured in a form of a coiled pipe (which reduces a position occupied). In the embodiment of the present disclosure, the second pipe body 23 adopts a coiled pipe structure. Furthermore, as shown in FIG. 1, the second pipe body 23 is wound on the slurry stirring barrel 11 to further reduce a space occupancy rate of the flotation slurry conditioning device.

The first end of the first pipe body 21 is detachably connected to the slurry outlet 112 of the stirring equipment 1 and the second end of the first pipe body 21 is detachably connected to the first connecting pipe body 22. The first connecting pipe body 22, the second pipe body 23, the second connecting pipe body 24 and the third connecting pipe body 25 are sequentially detachably connected. Detachable connection mode facilitates replacement of the first pipe body 21 and the second pipe body 23, so as to adjust the flow velocity of the slurry mixture in the second pipe body 23 and control size and contact angle of the interfacial micro-nano bubbles.

The driving equipment 3 is configured to convey the materials in the stirring equipment to enter the first pipe body 21, the first connecting pipe body 22, the second pipe body 23, the second connecting pipe body 24, and the third pipe body 25 in sequence. As shown in FIG. 1, the driving equipment 3 is a pump, which is disposed between the stirring equipment 1 and the first pipe body 21. However, the pump may also be disposed at a discharge end of the third pipe body 25 and the slurry mixture is conveyed by means of negative pressure (pumping).

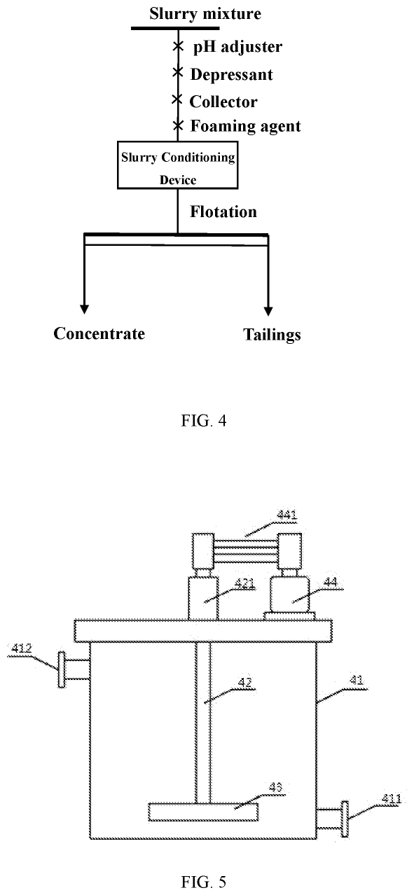

As shown in FIG. 4, FIG. 4 is a flow chart of slurry mixing-flotation principle. It can be concluded from FIG. 4 that the ore to be floated is prepared into slurry, and pH adjuster, depressant, collector, and foaming agent are added. Then, the slurry mixture is added to the flotation slurry conditioning device of the present disclosure, and the slurry mixture passes through the interfacial micro-nano bubble controller 2 and then enters the flotation cell (or flotation machine) for flotation to obtain target minerals.

As shown in FIG. 5, FIG. 5 is a schematic structural diagram of a conventional stirring device in the prior art. The conventional stirring device comprises a barrel 41, an ore outlet 412, an ore inlet 411, a driving shaft 42, a bearing 421, an impeller body 43, a driving motor 44, and a belt body 441. The ore inlet 411 is located at a lower portion of the barrel 41, and the ore outlet 412 is located at an upper portion of the barrel 41. The impeller body 43 is disposed on one end of the driving shaft 42 entering the barrel 41. The driving motor 44 provides power to the driving shaft 42 through the belt body 441. The bearing 421 is disposed on an upper end of the barrel 41. The driving shaft 42 passes through a middle portion of the bearing 421, and the bearing 421 makes the driving shaft 42 to run smoothly. The impeller body 43 is configured to stir the slurry mixture in the barrel 41. The stirred slurry mixture passes through the ore outlet 412 and then enters the flotation cell (or flotation machine) for flotation to obtain the target minerals.

FIGS. 1 -2 show a working process of the flotation slurry conditioning device of the present disclosure. The slurry flows into the slurry stirring barrel 11 through the slurry inlet 111, the motor 14 is turned on, and the motor 14 drives the transmission shaft 12 through the belt, The transmission shaft 12 drives the impeller 13 to rotate to stir the slurry. The bearing body 121 disposed on the top end of the transmission shaft 12 ensures stable rotation of the transmission shaft 12. The dosing port 114 and the water supply port 115 disposed on the upper end of the slurry stirring barrel are configured for adding the flotation reagents and water. The stirred slurry mixture flows into the pump 3 from the slurry outlet 112. An outlet end of the pump 3 is connected to the interfacial micro-nano bubble controller 2. The slurry mixture passes through the first pipe body 21, the first connecting pipe body 22, the second pipe body 23, the second connecting pipe body 24, and the third pipe body 25 of the interfacial micro-nano bubble controller 2 in sequence and then enters the flotation cell 6 (or flotation machine) for flotation. Since the inner diameter of the second pipe body 23 is less than the inner diameter of the first pipe body 21, the flow velocity of the slurry mixture increases when flowing through the second pipe body 23 to form a negative pressure. Therefore, due to the sudden pressure drop, the slurry mixture in the second pipe body 23 generates a large number of interfacial micro-nano bubbles caused by the diffusion of dissolved gas. The interfacial micro-nano bubbles are first generated on the surfaces of the minerals with better hydrophobicity. Therefore, the hydrophobicity of the minerals is selectively changed, so as to improve the adhesion efficiency of the target minerals and flotation bubbles, and promote the hydrophobic agglomeration of fine-grained minerals, and finally improve a flotation separation efficiency and reduce a dosage of the flotation reagents.

The present disclosure will be further described in detail below with reference to specific embodiments.

The size of the interfacial micro-nano bubbles generated in the flotation slurry conditioning device of the present discloses is in a range of 0.1-500 μm. The negative pressure is between a normal pressure and a saturated vapor pressure. The flow velocity of the slurry mixture is lower than that of common steam bubbles whose depressurization range is lower than the saturated steam pressure, so cavitation is not easy to occur, and equipment damage is avoided. The time-dependent changes in the size and contact angle of the interfacial micro-nano bubbles generated on surfaces of different minerals under pressure drop can be observed in two-dimensional by the device and method described in the Chinese patent ZL202010019381.3. Based on the Chinese patent, a three-dimensional observation device of the interfacial micro-nano bubbles is also developed to apply the common evolution law of a single interfacial micro-nano bubble to actual observations of the interfacial micro-nano bubble groups.

A core portion of the interfacial micro-nano bubble controller 2 of the present disclosure is various parameters of the second pipe body 23. Therefore, the present disclosure establishes the following mathematical models to obtain the flow velocity of the slurry mixture in the second pipe body 23, the inner diameter of the second pipe body 23, and a length of the second pipe body 23. As for the flow velocity, inner diameter, and length of other portions of the interfacial micro-nano bubble controller 2, they are determined according to actual site requirements. Generally, both of a length of the first pipe body 21 and a length of the third pipe body 25 are 0.1˜2 m, and both of lengths of the first connecting pipe body 22 and a length of the second connecting pipe body 24 range from 0.5 m to 1 m.

The inner diameter and length of the second pipe body 23 are obtained by the following methods:

Step 21: building a model to obtain a generation time T of the interfacial micro-nano bubbles and a pressure difference ΔP between the first pipe body and the second pipe body when a surface area difference of the interfacial micro-nano bubbles generated on surfaces of different minerals reaches maximum.

The interfacial micro-nano bubbles are spherical cap bubbles; the step of building the model in step 21 comprises:

Step 211: establishing a preliminary formula of a surface area of a single spherical cap bubble; establishing a preliminary formula of a volume change rate during bubble growth of a single spherical cap bubble; establishing a preliminary formula of a volume of the single spherical cap bubble.

The surface area of the single spherical cap bubble is:

S=2πRh=2πR²(1+cosθ) (3);

The volume change rate during bubble growth of the single spherical cap bubble is:

$$\frac{d V}{d t} = \frac{π D R sin θ}{{ρ}_{g}} [ {C}_{∞} - {C}_{s} ( 1 + \frac{2 σ}{R P} ) ] f ( θ ) ; \qquad ( 4 )$$

$$where$$

$$f ( θ ) = \frac{sin θ}{1 - cos θ} + 4 {\int }_{0}^{∞} \frac{1 + cosh [ 2 ( π - θ ) τ ]}{sinh 2 π τ} tanh ( θ τ ) {d}_{τ} ; \qquad ( 5 )$$

The volume of the single spherical cap bubble is:

$$V = \frac{π {R}^{3} ( 2 + 3 cos θ - {cos}^{3} θ )}{3} \qquad ( 6 )$$

h represents a height of the spherical cap bubble. θ represents a contact angle of the single spherical cap bubble. R represents a radius of the single spherical cap bubble. V represents a volume of the single spherical cap bubble. t represents a growth time of the single spherical cap bubble. D represents a diffusion coefficient of dissolved gas. ρ_{g} represents density of gas in the interfacial micro-nano bubbles generated on the surfaces of different types of minerals. P represents ambient pressure. σ represents bubble-liquid interfacial tension. C_{∞} represents a concentration of dissolved gas at an infinite distance from the single spherical cap bubble. Cs represents a concentration of the dissolved gas. t represents dimensionless time.

Step 212:establishing models of the single spherical cap bubble in different stages during a changing process of θ and R; wherein the different stages of the single spherical cap bubble comprise a floating stage where the contact angle of the single spherical cap bubble is changing and the radius of the single spherical cap bubble is constant, a transition stage where the radius and the contact angle of the single spherical cap bubble are changing, and an expansion stage where the radius of the single spherical cap bubble is changing and the contact angle of the single spherical cap bubble is constant.

Based on the diffusion theory, a model of the single spherical cap bubble in the floating stage where the contact angle of the single spherical cap bubble is changing and the radius of the single spherical cap bubble is constant is obtained from formulas (4) (5) (6) as follows:

$$\frac{d θ}{dt} = \frac{dV}{dt} \times \frac{1}{dV / d θ} = \frac{D}{ρ {R}^{2} {sin}^{2} θ} [ {C}_{s} ( 1 + \frac{2 σ}{R P} ) - {C}_{∞} ] f ( θ ) \qquad ( 7 )$$

Based on the diffusion theory, a model of the single spherical cap bubble in the transition stage where the radius and the contact angle of the single spherical cap bubble are changing is obtained from the formulas (4) (5) (6) as follows

$$\frac{d θ}{dt} = \frac{( 4.5 + 6.75 cos θ - 2.25 {cos}^{3} θ ) \times {10}^{- 6}}{R {sin}^{3} θ} + \frac{D}{ρ {R}^{2} {sin}^{2} θ} [ {C}_{s} ( 1 + \frac{2 σ}{RP} ) - {C}_{∞} ] f ( θ ) \qquad ( 8 )$$

Based on the diffusion theory, a model of the single spherical cap bubble in the expansion stage where the radius of the single spherical cap bubble is changing and the contact angle of the single spherical cap bubble is constant is obtained from the formulas (4) (5) (6) as follows:

$$\frac{dR}{dt} = \frac{d V}{dt} \times \frac{1}{dV / dR} = D \frac{{C}_{∞} - {C}_{s} ( 1 + \frac{2 σ}{RP} )}{ρ R {sin}^{3} θ} \frac{{( 1 - cos θ )}^{2}}{( 2 - cos θ )} f ( θ ) \qquad ( 9 )$$

Step 213: determining a change curve of the surface area S of the single spherical cap bubble at different time points t under different pressure differences AP by the Henry's formula and formulas (3), (7), (8), and (9); obtaining the generation time T of the interfacial micro-nano bubbles and the pressure difference ΔP according to the change curve when the surface areas difference of the interfacial micro-nano bubbles generated on the surfaces of different minerals reaches the maximum.

The Henry's formula is:

Cₛ=K_{H}P₂, C_{∞}=K_{H}P₁, ΔP=P₁-P₂;

K_{H} represents Henry's constant. A value of the Henry's constant is affected by temperature and solution properties. C_{∞} represents the concentration of the dissolved gas at the infinite distance from the single spherical cap bubble. Cₛ represents the concentration of the dissolved gas. It should be noted that the above formulas reveal a co-evolution law of the interfacial micro-nano bubbles. However, in practical applications, the interfacial micro-nano bubbles are generated in different time and are generated in a different order under same conditions. Thus, it is necessary to further refer to preliminary experimental results of three-dimensional observation of interfacial micro-nano bubble groups generated on the surfaces of different minerals in the slurry mixture to deduce an evolution law of a single interfacial micro-nano bubble to practice interfacial micro-nano bubbles, thereby obtaining effective values of T and ΔP in specific cases.

Step 22: obtaining a flow velocity of the slurry mixture in the second pipe body by combining the pressure difference ΔP obtained in step 21 and the Bernoulli's formula;

$${v}_{2} = \sqrt{2 g Δ H + {v}_{1}^{2} + \frac{2 ( {P}_{1} - {P}_{2} )}{ρ}} \qquad ( 1 )$$

P₁ represents a pressure of the slurry mixture in the first pipe body 21. P₂ represents a pressure of the slurry mixture in the second pipe body 23. ΔP=P₁-P₂. v₁ represents a flow velocity of the slurry mixture in the first pipe body 21. v₂ represents the flow velocity of the slurry mixture in the second pipe body 23. ρ represents a density of the slurry mixture. g represents an acceleration of gravity. ΔH represents a height difference between the first pipe body 21 and the second pipe body 23.

The inner diameter D₂ of the second pipe body is determined by:

$${D}_{2} = {D}_{1} \sqrt{\frac{{v}_{1}}{{v}_{2}}} . \qquad ( 10 )$$

Where D₁ is the inner diameter of the first pipe body 21; D₂ is the inner diameter of the second pipe body 23.

Step 23: obtaining the length of the second pipe body 23 according to the generation time T of the interfacial micro-nano bubbles obtained in step 21 and the flow velocity of the slurry mixture in the second pipe body 23;

L=v₂T (2)

Where L represents the length of the second pipe body. T represents time for the slurry mixture to pass through the second pipe body. It should be noted that the interfacial micro-nano bubbles are generated when ambient pressure drop and the generation time T of the interfacial micro-nano bubbles is equal to the time T for the slurry mixture to pass through the second pipe body.

Through the above formulas, the flow velocity of the slurry mixture in the second pipe body 23, the inner diameter D₂ of the second pipe body, and the length of the second pipe body 23 are calculated. For several common minerals, a ratio of the inner diameter of the first pipe body 21 and the inner diameter of the second pipe body 23 is 1:0.25˜0.6. The negative pressure of the slurry mixture in the second pipe body 23 range from 5 kPa˜101 kPa. The length of the second pipe body 23 ranges from 5˜60 m. In practical application, parameters of other components except the second pipe body 23 are firstly determined according to the specific situation, and then parameters of the second pipe body 23 are calculated by substituting into the formulas.

The ore is composed of different minerals, and the interfacial micro-nano bubbles are preferentially generated on hydrophobic/rough surfaces of the minerals. The generation of the interfacial micro-nano bubbles further enhances the hydrophobicity of the surfaces of the minerals, making surface properties of the minerals distinguishable from surface properties of other minerals that do not generate interfacial micro-nano bubbles. The process of flotation is a process in which minerals adhere to flotation bubbles and float. The stronger the hydrophobicity of the minerals, the easier they are to adhere to the flotation bubbles, and thus the easier they are to be selected. Generally, the target minerals are more hydrophobic than silicate gangue minerals, and various flotation reagents added in a slurry mixing process further expand the difference in surface properties between the two, which makes the surface hydrophobicity of the target minerals in the froth flotation system good. In the present disclosure, by providing of the interfacial micro-nano bubble controller 2, the surfaces of minerals in the slurry selectively generates interfacial micro-nano bubbles, which further improves the surface hydrophobicity of target minerals and gangue minerals, and promotes hydrophobic agglomeration of fine-grained minerals, thereby improving the flotation efficiency and reduced dosage of the flotation reagents.

### Embodiment 1

In the embodiment, the collector is butyl xanthate, the pH adjuster is lime, the depressant is water glass, the foaming agent is terpenic oil, and the froth flotation process is applied to enrich lead sulfide ore. The main useful minerals in the lead sulfide ore are galena with small sphalerite, and the lead grade of this lead sulfide ore is 2.2%. Other metal minerals in the lead sulfide ore comprise magnetite and pyrite, etc. The gangue minerals of the lead sulfide ore are mainly silicate minerals such as quartz and calcite.

An inner radius of the first pipe body 21 is 0.1 m, the flow velocity of the flurry mixture in the first pipe body is 1 m/s, and the length of the first pipe body is 1 m. An inner radius of the third pipe body 25 is 0.1 m, and a density of the slurry mixture is 1531 kg/m³. According to the formulas (1)˜(10) and the preliminary results of three-dimensional interfacial micro-nano bubbles observation, it is calculated that the pressure of the second pipe body 23 is 35 kPa, an inner radius of the second pipe body 23 is 0.031 m, the flow velocity of the slurry mixture in the second pipe body 23 is 10.11 m/s, and the length of the second pipe body 23 is 21.44 m. The height difference ΔH between the first pipe body and the third pipe body is 0.8 m.

In the embodiment, the slurry obtained after grinding of the lead sulfide ore is first added to the slurry stirring barrel, and the lime is added through the dosing port 114 to adjust a pH value to 8. Then, the water glass is added and stirred for 3 min, the ethyl xanthate is added and stirred for 3 min. and the terpenic oil is added and stirred for 1 min in sequence. Subsequently, the slurry mixture is conveyed into the slurry inlet 111 of the flotation slurry conditioning device of the present disclosure. The motor 14 is turned on, and the motor 14 drives the impeller 13 to rotate, and the slurry mixture is stirred. The slurry mixture flows out from the slurry outlet 112 and flows into the interfacial micro-nano bubble controller 2 through the pump 3 connected to the interfacial micro-nano bubble controller 2.

The structure of the interfacial micro-nano bubble controller 2 of the embodiment is shown in FIG. 3. The slurry mixture flows out from the third pipe body 25 and then enters the flotation cell of a conventional inflatable flotation machine to perform the flotation. The flotation time is 4 minutes. Galena concentrate and tailings are finally obtained by flotation. Then, the galena concentrate and the tailings are dried and weighed, respectively. Moreover, a Pb grade of the galena concentrate is analyzed to calculate the galena recovery. Compared with a treatment result of a conventional stirring device (as a blank experiment), except that the flotation slurry conditioning device used before flotation is different and the dosage of the added flotation reagents is less in the present disclosure, the operations performed in the present disclosure are same as those in the blank experiment. The above operations are repeated, and a grinding fineness of the lead sulfide ore is that the content of −200 mesh (−0.074 mm) lead sulfide ore is accounted for 60%, 70%, 80%, and 90%, respectively.

TABLE 1
(Table of grade, recovery, and dosage of the concentrate obtained by flotation of the galena in Embodiment 1)

| | | | | Flotation slurry conditioning device | | |
|---|---|---|---|---|---|---|
| | Conventional stirring device | | | of the present disclosure | | |
| Grinding | Concentrate | Concentrate | | Concentrate | Concentrate | |
| fineness | grade | Recovery | Total | grade | Recovery | Total |
| (%) | (%) | (%) | dosage(g/t) | (%) | (%) | dosage(g/t) |
| 60 | 39.20 | 61.86 | 300 g/t water glass, | 48.75 | 68.34 | 200 g/t water glass, |
| 70 | 44.36 | 63.52 | 100 g/t Butyl xanthate, | 52.82 | 71.25 | 50 g/t Butyl xanthate, |
| 80 | 47.55 | 66.32 | 10 g/t terpenic oil | 58.02 | 76.11 | 10 g/t terpenic oil |
| 90 | 55.23 | 69.46 | | 63.40 | 80.08 | |

Table 1 shows a comparison of flotation results between the conventional stirring device and the flotation slurry conditioning device of the present disclosure in the embodiment. It can be seen from Table 1 that the grade of the flotation concentrate and the recovery of the slurry mixture treated by the flotation slurry conditioning device of the present disclosure are improved. When the grinding fineness is 60%, the Pb grade of the concentrate treated by the flotation slurry conditioning device of the present disclosure is 48.75%, the recovery is 68.34%. Compared with the conventional stirring device, the Pb grade of the concentrate treated by the flotation slurry conditioning device of the present disclosure is increased by 9.55%, and the recovery thereof is increased by 6.48%. When the grinding fineness is 70%, the Pb grade of the concentrate treated by the flotation slurry conditioning device of the present disclosure is 52.82%, the recovery is 71.25%. Compared with the conventional stirring device, the Pb grade of the concentrate treated by the flotation slurry conditioning device of the present disclosure is increased by 8.46%, and the recovery thereof is increased by 7.73%. When the grinding fineness is 80%, the Pb grade of the concentrate treated by the flotation slurry conditioning device of the present disclosure is 58.02%, the recovery is 76.11%. Compared with the conventional stirring device, the Pb grade of the concentrate treated by the flotation slurry conditioning device of the present disclosure is increased by 10.47%, and the recovery thereof is increased by 9.79%. When the grinding fineness is 90%, the Pb grade of the concentrate treated by the flotation slurry conditioning device of the present disclosure is 63.40%, the recovery is 80.08%. Compared with the conventional stirring device, the Pb grade of the concentrate treated by the flotation slurry conditioning device of the present disclosure is increased by 12.17%, and the recovery thereof is increased by 8.17%. Thus, it is indicated that the grade and recovery of the concentrate obtained by flotation of the galena using the flotation slurry conditioning device of the present disclosure are greatly improved compared with that of the conventional stirring device, and the dosage of flotation reagents is reduced.

### Embodiment 2

In the embodiment, the collector is dodecylamine, the depressant is water glass, and the pH adjuster is hydrofluoric acid. A reverse flotation for separation of feldspar from quartz sand is performed. Useful minerals of the quartz sand are quartz with a grade of 70.12%. The gangue minerals of the quartz sand are mainly feldspar and trace amounts of sericite, pyrite, and anatase.

An inner radius of the first pipe body 21 is 0.1 m, the flow velocity of the flurry mixture in the first pipe body is 0.5 m/s, and the length of the first pipe body is 1 m. An inner radius of the third pipe body 25 is 0.1 m, and a density of the slurry mixture is 1122 kg/m³. According to the formulas (1)˜(10) and the preliminary results of three-dimensional interfacial micro-nano bubbles observation, it is calculated that the pressure of the second pipe body 23 is 35 kPa, an inner radius of the second pipe body 23 is 0.029 m, the flow velocity of the slurry mixture in the second pipe body 23 is 11.56 m/s, and the length of the second pipe body 23 is 36.24 m. The height difference ΔH between the first pipe body and the third pipe body is 0.8 m.

In the embodiment, the slurry obtained after grinding of the quartz sand is first added to the slurry stirring barrel, and the hydrofluoric acid is added through the dosing port 114 to adjust a pH value to 2. Then, the water glass is added and stirred for 3 min, and the dodecylamine is added and stirred for 3 min in sequence. Subsequently, the slurry mixture is conveyed into the slurry inlet 111 of the flotation slurry conditioning device of the present disclosure. The motor 14 is turned on, and the motor 14 drives the impeller 13 to rotate, and the slurry mixture is stirred. The slurry mixture flows out from the slurry outlet 112 and flows into the interfacial micro-nano bubble controller 2 through the pump 3 connected to the interfacial micro-nano bubble controller 2.

The structure of the interfacial micro-nano bubble controller 2 of the embodiment is shown in FIG. 3. The slurry mixture flows out from the third pipe body 25 and then enters the flotation cell of a conventional inflatable flotation machine to perform the flotation. The flotation time is 4.5 minutes. Quartz concentrate and tailings are finally obtained by flotation. Then, the quartz concentrate and the tailings are dried and weighed, respectively. Moreover, the SiO₂ grade of the quartz concentrate is analyzed to calculate the quartz recovery. Compared with a treatment result of a conventional stirring device (as a blank experiment), except that the flotation slurry conditioning device used before flotation is different and the dosage of the added flotation reagents is less in the present disclosure, the operations performed in the present disclosure are same as those in the blank experiment. The above operations are repeated, and a grinding fineness of the quartz sand is that the content of −200 mesh (−0.074 mm) quartz sand is accounted for 60%, 70%, 80%, and 90%, respectively.

TABLE 2
(Table of grade, recovery, and dosage of the concentrate
obtained by flotation of the quartz sand in Embodiment 2)

| | | | | Flotation slurry conditioning device | | |
|---|---|---|---|---|---|---|
| | Conventional stirring device | | | of the present disclosure | | |
| Grinding | Concentrate | Concentrate | | Concentrate | Concentrate | |
| fineness | grade | Recovery | Total | grade | Recovery | Total |
| (%) | (%) | (%) | dosage(g/t) | (%) | (%) | dosage(g/t) |
| 60 | 83.06 | 74.41 | 600 g/t water glass, | 91.77 | 80.70 | 400 g/t water glass; |
| 70 | 44.36 | 63.52 | 600 g/t dodecylamine | 52.82 | 71.25 | 300 g/t dodecylamine |
| 80 | 47.55 | 66.32 | | 58.02 | 76.11 | |
| 90 | 55.23 | 69.46 | | 63.40 | 80.08 | |

Table 2 shows a comparison of flotation results between the conventional stirring device and the flotation slurry conditioning device of the present disclosure in the embodiment. It can be seen from Table 1 that the grade of the flotation concentrate and the recovery of the slurry mixture treated by the flotation slurry conditioning device of the present disclosure are improved. When the grinding fineness is 60%, the SiO₂ grade of the concentrate treated by the flotation slurry conditioning device of the present disclosure is 91.77%, the recovery is 80.7%. Compared with the conventional stirring device, the SiO₂ grade of the concentrate treated by the flotation slurry conditioning device of the present disclosure is increased by 8.71%, and the recovery thereof is increased by 6.29%. When the grinding fineness is 70%, the SiO₂ grade of the concentrate treated by the flotation slurry conditioning device of the present disclosure is 98.83%, the recovery is 84.09%. Compared with the conventional stirring device, the SiO₂ grade of the concentrate treated by the flotation slurry conditioning device of the present disclosure is increased by 9.70%, and the recovery thereof is increased by 4.93%. When the grinding fineness is 80%, the SiO₂ grade of the concentrate treated by the flotation slurry conditioning device of the present disclosure is 99.63%, the recovery is 77.58%. Compared with the conventional stirring device, the SiO₂ grade of the concentrate treated by the flotation slurry conditioning device of the present disclosure is increased by 6.08%, and the recovery thereof is increased by 6.85%. When the grinding fineness is 90%, the SiO₂ grade of the concentrate treated by the flotation slurry conditioning device of the present disclosure is 99.38%, the recovery is 68.92%. Compared with the conventional stirring device, the SiO₂ grade of the concentrate treated by the flotation slurry conditioning device of the present disclosure is increased by 1.58%, and the recovery thereof is increased by 4.42%. Thus, it is indicated that the grade and recovery of the concentrate obtained by reverse flotation of the quartz sand using the flotation slurry conditioning device of the present disclosure are greatly improved compared with that of the conventional stirring device, and the dosage of flotation reagents is reduced.

### Embodiment 3

In the embodiment, the collector is dodecylamine, the depressant is starch, and the pH adjuster is sodium hydroxide. A reverse flotation is performed to separate quartz from hematite. The useful minerals in iron ore are hematite, the content of TFe is 30.42%, and the content of iron minerals is 43.46%. The gangue minerals of the raw iron ore are mainly quartz, followed by pyroxene, amphibole, mica and clay minerals.

An inner radius of the first pipe body 21 is 0.1 m, the flow velocity of the flurry mixture in the first pipe body is 1 m/s, and the length of the first pipe body is 1 m. An inner radius of the third pipe body 25 is 0.1 m, and a density of the slurry mixture is 1316 kg/m³. According to the formulas (1)˜(10) and the preliminary results of three-dimensional interfacial micro-nano bubbles observation, it is calculated that the pressure of the second pipe body 23 is 30 kPa, an inner radius of the second pipe body 23 is 0.030 m, the flow velocity of the slurry mixture in the second pipe body 23 is 11.13 m/s, and the length of the second pipe body 23 is 27.83 m. The height difference ΔH between the first pipe body and the third pipe body is 0.8 m.

In the embodiment, the slurry obtained after grinding of the raw hematite is first added to the slurry stirring barrel. Then the sodium hydroxide is added to adjust the pH to be weakly alkaline. The starch is added and stirred for 3 min and the dodecylamine is added and stirred for 3 min in sequence. Subsequently, the slurry mixture is conveyed into the slurry inlet 111 of the flotation slurry conditioning device of the present disclosure. The motor 14 is turned on, and the motor 14 drives the impeller 13 to rotate, and the slurry mixture is stirred. The slurry mixture flows out from the slurry outlet 112 and flows into the interfacial micro-nano bubble controller 2 through the pump 3 connected to the interfacial micro-nano bubble controller 2. The structure of the interfacial micro-nano bubble controller 2 of the embodiment is shown in FIG. 3. The slurry mixture flows out from the third pipe body 25 and then enters the flotation cell of a conventional inflatable flotation machine to perform the flotation. The flotation time is 5 minutes. Hematite concentrate and tailings are finally obtained by flotation. Then, the hematite concentrate and the tailings are dried and weighed, respectively. Moreover, the grade of the Fe in the hematite concentrate is analyzed to calculate the hematite recovery. Compared with a treatment result of a conventional stirring device (as a blank experiment), except that the flotation slurry conditioning device used before flotation is different and the dosage of the added flotation reagents is less in the present disclosure, the operations performed in the present disclosure are same as those in the blank experiment. The above operations was repeated, and a grinding fineness of the ore is that the content of −200 mesh (−0.074 mm) slurry is accounted for 60%, 70%, 80% and 90% resnectivelv

TABLE 3
(Table of grade, recovery, and dosage of the concentrate
obtained by flotation of the hematite in Embodiment 3)

| | | | | Flotation slurry conditioning device | | |
|---|---|---|---|---|---|---|
| | Conventional stirring device | | | of the present disclosure | | |
| Grinding | Concentrate | Concentrate | | Concentrate | Concentrate | |
| fineness | grade | Recovery | Total | grade | Recovery | Total |
| (%) | (%) | (%) | dosage(g/t) | (%) | (%) | dosage(g/t) |
| 60 | 47.22 | 68.40 | 100 g/t starch, | 54.80 | 75.12 | 80 g/t starch, |
| 70 | 44.36 | 63.52 | 450 g/t dodecylamine | 52.82 | 71.25 | 300 g/t dodecylamine |
| 80 | 47.55 | 66.32 | | 58.02 | 76.11 | |
| 90 | 55.23 | 69.46 | | 63.40 | 80.08 | |

Table 3 shows a comparison of flotation results between the conventional stirring device and the flotation slurry conditioning device of the present disclosure in the embodiment. It can be seen from Table 3 that the grade of the flotation concentrate and the recovery of the slurry mixture treated by the flotation slurry conditioning device of the present disclosure are improved. When the grinding fineness is 60%, the Fe grade of the concentrate treated by the flotation slurry conditioning device of the present disclosure is 54.80%, the recovery is 75.82%. Compared with the conventional stirring device, the Fe grade of the concentrate treated by the flotation slurry conditioning device of the present disclosure is increased by 7.58%, and the recovery thereof is increased by 6.72%.

When the grinding fineness is 70%, the Fe grade of the concentrate treated by the flotation slurry conditioning device of the present disclosure is 61.83%, the recovery is 81.42%. Compared with the conventional stirring device, the Fe grade of the concentrate treated by the flotation slurry conditioning device of the present disclosure is increased by 9.80%, and the recovery thereof is increased by 6.98%. When the grinding fineness is 80%, the Fe grade of the concentrate treated by the flotation slurry conditioning device of the present disclosure is 68.93%, the recovery is 87.30%. Compared with the conventional stirring device, the Fe grade of the concentrate treated by the flotation slurry conditioning device of the present disclosure is increased by 9.28%, and the recovery thereof is increased by 11.02%. When the grinding fineness is 90%, the Fe grade of the concentrate treated by the flotation slurry conditioning device of the present disclosure is 66.60%, the recovery is 84.52%. Compared with the conventional stirring device, the Fe grade of the concentrate treated by the flotation slurry conditioning device of the present disclosure is increased by 8.28%, and the recovery thereof is increased by 12.37%. Thus, it is indicated that the grade and recovery of the concentrate obtained by reverse flotation of the hematite using the flotation slurry conditioning device of the present disclosure are greatly improved compared with that of the conventional stirring device, and the dosage of flotation reagents is reduced.

### Embodiment 4

In the embodiment, the collector is kerosene and the foaming agent is sec-octanol. A froth flotation is performed to separate quartz and kaolinite in coal mines. The useful minerals of the raw coal are coal; the gangue minerals in the raw coal are mainly quartz and kaolinite.

An inner radius of the first pipe body 21 is 0.1 m, the flow velocity of the flurry mixture in the first pipe body is 1 m/s, and the length of the first pipe body is 1 m. An inner radius of the third pipe body 25 is 0.1 m, and a density of the slurry mixture is 1053 kg/m³. According to the formulas (1)˜(10) and the preliminary results of three-dimensional interfacial micro-nano bubbles observation, it is calculated that the pressure of the second pipe body 23 is 60 kPa, an inner radius of the second pipe body 23 is 0.032 m, the flow velocity of the slurry mixture in the second pipe body 23 is 9.69 m/s, and the length of the second pipe body 23 is 19.07 m. The height difference ΔH between the first pipe body and the third pipe body is 0.8 m.

In the embodiment, the slurry obtained after grinding of the raw coal mines is first added to the slurry stirring barrel. Then the kerosene is added and stirred for 3 min and the sec-octanol is added and stirred for 3min in sequence. Subsequently, the slurry mixture is conveyed into the slurry inlet 111 of the flotation slurry conditioning device of the present disclosure. The motor 14 is turned on, and the motor 14 drives the impeller 13 to rotate, and the slurry mixture is stirred. The slurry mixture flows out from the slurry outlet 112 and flows into the interfacial micro-nano bubble controller 2 through the pump 3 connected to the interfacial micro-nano bubble controller 2.

The structure of the interfacial micro-nano bubble controller 2 of the embodiment is shown in FIG. 3. The slurry mixture flows out from the third pipe body 25 and then enters the flotation cell of a conventional inflatable flotation machine to perform the flotation. The flotation time is 3 minutes. Coal concentrate and tailings are finally obtained by flotation. Then, the coal concentrate and the tailings are dried and weighed to calculate the concentrate yields, and the content of the ash in the coal concentrate is also analyzed. Compared with a treatment result of a conventional stirring device (as a blank experiment), except that the flotation slurry conditioning device used before flotation is different and the dosage of the added flotation reagents is less in the present disclosure, the operations performed in the present disclosure are same as those in the blank experiment. The above operations are repeated, and a grinding fineness of the raw coal mines is that the content of −200 mesh (−0.074 mm) slurry is accounted for 60%, 70%, 80%, and 90%, respectively.

TABLE 4
(Table of grade, recovery, and dosage of the concentrate obtained
by flotation of the raw coal mines e in Embodiment 4)

| | | | | flotation slurry conditioning device | | |
|---|---|---|---|---|---|---|
| | Conventional stirring device | | | of the present disclosure | | |
| Grinding | Concentrate | Concentrate | | Concentrate | Concentrate | |
| fineness | grade | Recovery | Total | grade | Recovery | Total |
| (%) | (%) | (%) | dosage(g/t) | (%) | (%) | dosage(g/t) |
| 60 | 47.22 | 68.40 | 100 g/t starch, | 54.80 | 75.12 | 80 g/t starch, |
| 70 | 44.36 | 63.52 | 450 g/t dodecylamine | 52.82 | 71.25 | 300 g/t dodecylamine |
| 80 | 47.55 | 66.32 | | 58.02 | 76.11 | |
| 90 | 55.23 | 69.46 | | 63.40 | 80.08 | |

Table 4 shows a comparison of flotation results between the conventional stirring device and the flotation slurry conditioning device of the present disclosure in the embodiment. It can be seen from Table 4 that the grade of the flotation concentrate and the recovery of the slurry mixture treated by the flotation slurry conditioning device of the present disclosure are improved. When the grinding fineness is 60%, a yield of the coal concentrate obtained by the flotation slurry conditioning device of the present disclosure is 78.10% and a yield of the ash content is 7.66%. Compared with the conventional stirring device, the yield of the coal concentrate obtained is increased by 8.80%, and the yield of the ash content is reduced by 2.86%.

When the grinding fineness is 70%, the yield of the coal concentrate obtained by the flotation slurry conditioning device of the present disclosure is 80.04% and the yield of the ash content is 6.25%. Compared with the conventional stirring device, the yield of the coal concentrate obtained is increased by 7.52%, and the yield of the ash content is reduced by 3.30%. When the grinding fineness is 80%, the yield of the coal concentrate obtained by the flotation slurry conditioning device of the present disclosure is 86.22% and the yield of the ash content is 5.63%. Compared with the conventional stirring device, the yield of the coal concentrate obtained is increased by 8.36%, and the yield of the ash content is reduced by 3.57%. When the grinding fineness is 90%, the yield of the coal concentrate obtained by the flotation slurry conditioning device of the present disclosure is 82.67% and the yield of the ash content is 6.75%. Compared with the conventional stirring device, the yield of the coal concentrate obtained is increased by 6.82%, and the yield of the ash content is reduced by 2.67%. Thus, it is indicated that the yield of the coal concentrate obtained by froth flotation using the flotation slurry conditioning device of the present disclosure is greatly improved and the ash content obtained by froth flotation using the flotation slurry conditioning device of the present disclosure is greatly reduced compared with that of the conventional stirring device, and the dosage of flotation reagents is reduced.

The above-mentioned embodiments are optionally embodiments of the present disclosure. However, the embodiments of the present disclosure are not limited by the above-mentioned embodiments. Any changes, modifications, substitutions, combinations and simplifications made without departing from the spirit and principle of the present disclosure shall be regarded as equivalent substitutions, which still falls within the protection scope of technical solutions of the present disclosure.

What is claimed is:

1. A flotation slurry conditioning method based on controlling interfacial micro-nano bubbles, comprising following steps:
step 1: adding slurry and flotation reagents into a stirring equipment to make minerals evenly dispersed and fully interact with the flotation reagents; and
step 2: conveying slurry mixture obtained in the step 1 into a flotation cell for flotation; wherein during a conveying process of the slurry mixture, adjusting a fluid pressure in different conveying sections to make surfaces of the minerals in the slurry mixture generating interfacial micro-nano bubbles.

2. The flotation slurry conditioning method based on controlling the interfacial micro-nano bubbles according to claim 1, wherein the different conveying sections at least comprise a first conveying section and a second conveying section arranged in sequence along a conveying direction; an inner diameter of the first conveying section is greater than an inner diameter of the second conveying section.

3. The flotation slurry conditioning method based on controlling the interfacial micro-nano bubbles according to claim 2, wherein a length of the second conveying section is obtained by:
step 21: building a model to obtain a generation time T of the interfacial micro-nano bubbles and a pressure difference AP between the first conveying section and the second conveying section when a surface areas difference of the interfacial micro-nano bubbles generated on surfaces of different minerals reaches maximum;
step 22: obtaining a flow velocity of the slurry mixture in the second conveying section by combining the pressure difference AP obtained in step 21 and the Bernoulli's equation;
$${v}_{2} = \sqrt{2 g Δ H + {v}_{1}^{2} + \frac{2 ( {P}_{1} - {P}_{2} )}{ρ}} \qquad ( 1 )$$
wherein P₁ represents a pressure of the slurry mixture in the first conveying section; P₂ represents a pressure of the slurry mixture in the second conveying section; ΔP=P₁-P₂; v₁ represents a flow velocity of the slurry mixture in the first conveying section; v₂ represents the flow velocity of the slurry mixture in the second conveying section; ρ represents a density of the slurry mixture; g represents an acceleration of gravity; ΔH represents a height difference between the first conveying section and the second conveying section;
step 23: obtaining the length of the second conveying section according to the generation time T of the interfacial micro-nano bubbles obtained in step 21 and the flow velocity of the slurry mixture in the second conveying section;
L=v₇T (2)
wherein L represents the length of the second conveying section; T represents time for the slurry mixture to pass through the second conveying section; wherein the interfacial micro-nano bubbles are generated when ambient pressure drop and the generation time of the interfacial micro-nano bubbles is equal to the time for the slurry mixture to pass through the second conveying section.

4. The flotation slurry conditioning method based on controlling the interfacial micro-nano bubbles according to claim 3, wherein the interfacial micro-nano bubbles are spherical cap bubbles; the step of building the model in step 21 comprises:
step 211: establishing a preliminary formula of a surface area of a single spherical cap bubble of the spherical cap bubbles; establishing a preliminary formula of a volume change rate of the single spherical cap bubble during bubble growth; establishing a preliminary formula of a volume of the single spherical cap bubble; wherein the surface area of the single spherical cap bubble is:
S=2πRh=2πR²(1+cosθ)) (3);
wherein the volume change rate of the single spherical cap bubble during bubble growth is:
$$\frac{d V}{d t} = \frac{π D R sin θ}{{ρ}_{g}} [ {C}_{∞} - {C}_{s} ( 1 + \frac{2 σ}{R P} ) ] f ( θ ) ; \qquad ( 4 )$$
$$where$$
$$f ( θ ) = \frac{sin θ}{1 - cos θ} + 4 {\int }_{0}^{∞} \frac{1 + cosh [ 2 ( π - θ ) τ ]}{sinh 2 π τ} tanh ( θ τ ) {d}_{τ} ; \qquad ( 5 )$$
wherein the volume of the single spherical cap bubble is:
$$V = \frac{π {R}^{3} ( 2 + 3 cos θ - {cos}^{3} θ )}{3} \qquad ( 6 )$$
wherein h represents a height of the spherical cap bubble; θ represents a contact angle of the single spherical cap bubble; R represents a radius of the single spherical cap bubble; V represents a volume of the single spherical cap bubble; t represents a growth time of the single spherical cap bubble; D represents a diffusion coefficient of dissolved gas; ρ_{g} represents density of gas in the interfacial micro-nano bubbles generated on the surfaces of different types of minerals; P represents ambient pressure; σ represents bubble-liquid interfacial tension; C_{∞} represents a concentration of dissolved gas at an infinite distance from the single spherical cap bubble; Cs represents a concentration of the dissolved gas; t represents dimensionless time;
step 212: establishing models of the single spherical cap bubble in different stages during a changing process of θ and R; wherein the different stages of the single spherical cap bubble comprise a floating stage where the contact angle of the single spherical cap bubble is changing and the radius of the single spherical cap bubble is constant, a transition stage where the radius and the contact angle of the single spherical cap bubble are changing, and an expansion stage where the radius of the single spherical cap bubble is changing and the contact angle of the single spherical cap bubble is constant;
wherein based on the diffusion theory, a model of the single spherical cap bubble in the floating stage where the contact angle of the single spherical cap bubble is changing and the radius of the single spherical cap bubble is constant is obtained from formulas (4) (5) (6) as follows:
$$\frac{d θ}{dt} = \frac{dV}{dt} \times \frac{1}{dV / d θ} = \frac{D}{ρ {R}^{2} {sin}^{2} θ} [ {C}_{s} ( 1 + \frac{2 σ}{R P} ) - {C}_{∞} ] f ( θ ) \qquad ( 7 )$$
wherein based on the diffusion theory, a model of the single spherical cap bubble in the transition stage where the radius and the contact angle of the single spherical cap bubble are changing is obtained from the formulas (4) (5) (6) as follows:
$$\frac{d θ}{dt} = \frac{( 4.5 + 6.75 cos θ - 2.25 {cos}^{3} θ ) \times {10}^{- 6}}{R {sin}^{3} θ} + \frac{D}{ρ {R}^{2} {sin}^{2} θ} [ {C}_{s} ( 1 + \frac{2 σ}{RP} ) - {C}_{∞} ] f ( θ ) \qquad ( 8 )$$
wherein based on the diffusion theory, a model of the single spherical cap bubble in the expansion stage where the radius of the single spherical cap bubble is changing and the contact angle of the single spherical cap bubble is constant is obtained from the formulas (4) (5) (6) as follows:
$$\frac{dR}{dt} = \frac{d V}{dt} \times \frac{1}{dV / dR} = D \frac{{C}_{∞} - {C}_{s} ( 1 + \frac{2 σ}{RP} )}{ρ R {sin}^{3} θ} \frac{{( 1 - cos θ )}^{2}}{( 2 - cos θ )} f ( θ ) \qquad ( 9 )$$
step 213: determining a change curve of the surface area S of the single spherical cap bubble at different time points t under different pressure differences ΔP by the Henry's formula and formulas (3), (7), (8), and (9); obtaining the generation time T of the interfacial micro-nano bubbles and the pressure difference ΔP according to the change curve when the surface areas difference of the interfacial micro-nano bubbles generated on the surfaces of different minerals reaches the maximum;
wherein the Henry's formula is:
Cₛ=K_{H}P₂, C_{∞}=K_{H}P₁, ΔP=P₁−P₂,
wherein K_{H} represents Henry's constant; a value of the Henry's constant is affected by temperature and solution properties; C_{∞}represents the concentration of the dissolved gas at the infinite distance from the single spherical cap bubble; Cs represents the concentration of the dissolved gas.

5. The flotation slurry conditioning method based on controlling the interfacial micro-nano bubbles according to claim 3, wherein the step 22 further comprises determining the inner diameter D₂ of the second conveying section:
$${D}_{2} = {D}_{1} \sqrt{\frac{{v}_{1}}{{v}_{2}}} . \qquad ( 10 )$$
wherein D₁ is the inner diameter of the first conveying section; D₂ is the inner diameter of the second conveying section.

6. The flotation slurry conditioning method based on controlling the interfacial micro-nano bubbles according to claim 1, wherein the slurry is selected from non-ferrous metal sulfide slurry, non-ferrous metal oxide slurry; non-metallic pulp, ferrous metal slurry, oxygen-containing salt slurry, and coal slurry.

7. The flotation slurry conditioning method based on controlling the interfacial micro-nano bubbles according to claim 1, wherein the flotation reagents are one or more of a collector, a pH adjuster, a depressant, and a foaming agent.
